(19) United States
(12) Patent Application Publication
(10) Pub. No.: US 2009/0187664 A1
(43) Pub. Date: Jul. 23, 2009

(54) Method for addressing call transmission and service elements between heterogenous nodes

(75) Inventors: Mohamed Boucadair, Caen (FR); Yoann Noisette, May Sur Orne (FR)

Correspondence Address: MCKENNA LONG & ALDRIDGE LLP, 1900 K STREET, NW, WASHINGTON, DC, 20006, US

(73) Assignee: France Telecom, Paris (FR)

(21) Appl. No.: 12/308,889

(22) PCT Filed: Jun. 26, 2007
(86) PCT No.: PCT/FR2007/051531

§ 371 Date: Dec. 29, 2008

(30) Foreign Application Priority Data
Jun. 30, 2006 (FR) 0605945

(51) Int. Cl. G06F 15/16

(52) U.S. Cl. 709/228

(57) ABSTRACT

A SIP server addressing method for the inter-operation of SIP nodes (A, B) of a determined IP type in which each SIP server (P, R) is attributed (A) an auxiliary address (R₂@v4, P₂@v4) of the same IP type as their original address (R₁@v4, P₁@v4), wherein the auxiliary address corresponds to a distinct IP type communication address, all SIP nodes of the same IP type as this SIP server are supplied (B) with the original address, and to all SIP nodes with an IP type distinct from the IP type of this SIP server, this communication address and the communication address of one of the IP types is translated (C) into the auxiliary address, of the same IP type as the IP type of the original address.

The invention lies in the field of telecommunications, and more particular in that of telephony over IP.

Networks complying with a communication protocol called IP (an abbreviation well known to those skilled in the art standing for Internet Protocol) are being used with increasing frequency as universal media for a multitude of services and applications. This IP protocol has played a federating role with many operators who have chosen this protocol to share hitherto disparate service offerings.

IPv4 is a version of the IP communication protocol that has been used for years.

To satisfy the constraints imposed by such communication services, and more particularly to respond to the increasing needs in terms of addresses, operators and manufacturers of network equipment have joined together to specify a new generation communication protocol, commonly called IPv6, defined by specifications and analysis documents that are at a sufficiently advanced development stage to make it possible now to envisage an operational deployment in the operators' networks.

Nevertheless, the introduction of this new protocol generation poses significant problems associated with a need to ensure interoperability and interworking of the IPv6 protocol and the IPv4 protocol which is already deployed in the IP networks.

In the transport layer, mechanisms have been proposed and even standardized at the IETF (an abbreviation well known to those skilled in the art standing for Internet Engineering Task Force) such as a technique called NAT-PT and various techniques known as “tunneling” and consisting in encapsulating IPv6 data in IPv4 datagrams or vice versa.

In addition, upgrades and adaptations of service architectures and platforms are necessary to allow interworking between clients situated in IP environments of different types (IPv4 or IPv6) in as transparent a manner as possible for the end client.

Amongst its multimedia activities, the IETF has standardized a protocol called SIP (an abbreviation well known to those skilled in the art standing for Session Initiation Protocol) offering as its main functions the initiation, modification and termination of multimedia sessions. The SIP protocol is an interesting example of an application of the present invention. The SIP protocol uses an SDP protocol (an abbreviation well known to those skilled in the art standing for Session Description Protocol) to produce a description of parameters associated with the session concerned. Once a negotiation has been successful between two parties participating in a call, the latter may interchange media streams thanks to an activation of an RTP (an abbreviation well known to those skilled in the art standing for Real Time Transport Protocol) protocol. RTP session parameters are prenegotiated via SIP signaling messages, notably in the SDP portion. These parameters are mainly termination addresses and port numbers that will be used on either side.

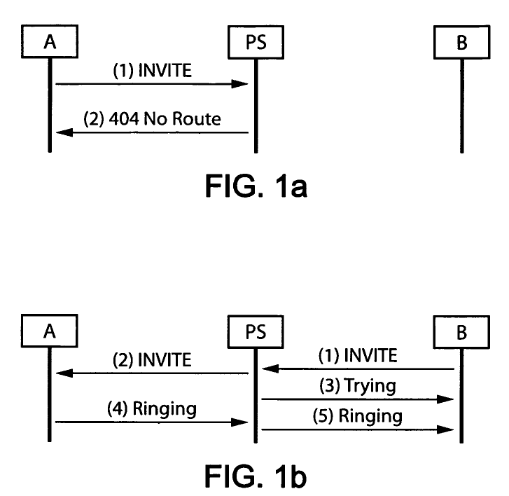

Since the first version of the SIP protocol described in a document referenced RFC 2543 (RFC meaning “Request For Comment”), the latter has supported the IPv6 protocol. An implementation complying with RFC 2543 or with its update RFC3261 in principle easily decodes addresses that conform to the IPv4 and IPv6 protocols. Such an address may be inserted in a specific field such as a “CONTACT” header or in headers of the SDP portion. However, the presence of such addresses may prevent the setting-up of SIP calls if the two terminals cannot be reached in one and the same IP environment, that is, if one has an IPv4 address and the other an IPv6 address. Thus, when a user agent of IPv4 type A initiates an SIP session to a user agent of IPv6 type that is registered with an IPv4 location server (marked R hereinafter), the interchange of SIP messages produced is described in figure la, where a first user agent A wishing to make contact with a second user agent B sends an “INVITE” message to a proxy server (marked PS hereinafter) by using an IPv4 address specific to the latter. The proxy server PS is in this instance a server attached to an exclusively IPv4 environment. Once the message is received by the proxy server PS, the latter makes a request to a location server also called a registration server and thereby retrieves the address of the second under agent B. Since this address can be assumed to be an IPv6 address, the proxy server PS does not know any route to this destination because this proxy server PS is exclusively of the IPv4 type. An error message is then sent to the user agent A stating that it is impossible to set up an SIP session between the first and second user agents A and B. This error message is marked (2)404 “No Route” in FIG. 1a.

If it is now supposed that the proxy server PS can nevertheless reach the location address of the first user agent A and that of the user agent B, another interchange of SIP messages is observed, when the second user agent B tries to call the first user agent A, as represented in FIG. 1b.

In this situation, the proxy server PS routes an “INVITE” message received from the second user agent B to the location address of the first user agent A. This “INVITE” message contains an SDP offer describing, in addition to the capabilities offered by the first user agent B in terms of CODEC (for coder/decoder), an RTP port number and an address that the second user agent B will use to transmit/receive RTP streams. In the situation of FIG. 1b, this address is of the IPv6 type. Thus, when the user agent A receives this “INVITE” message, it can only refuse to open the session because this user agent is an IPv4 client. According to the implementations, the best it can do is to return an error message indicating that it does not support network connections to the IP address of the user agent B. In both of the preceding examples, described in connection with FIGS. 1a and 1b, the SIP sessions therefore cannot be set up.

A coexistence of IP addresses of different types could affect calls other than those that have been the subject of the graphic representation described above. Thus, calls to clients of the DS IP type (DS being an abbreviation well known to those skilled in the art standing for Dual Stack), may also not culminate in media stream interchanges, the user agents of the DS type being capable of processing both IPv4 and IPv6 address types. This is due to the fact that the basic SIP protocol allows only a single IP address to be entered for transmitting or receiving media streams. To alleviate this problem, documents referenced RFC 4092 and RFC 4091 introduce a new semantic element consisting, amongst other things, in defining an indicator denoted “sdp-anat”. This new semantic element allows a user agent to announce and/or discover one or more address types. Therefore, user agents of the dual stack type are able to indicate in their SDP offer both their IPv4 and IPv6 addresses. Thanks to this technique, all calls from/to a user agent of the DS type to single-version clients (i.e. compatible with the IPv4 protocol only or with the IPv6 protocol only) may give rise to successful SIP sessions.

If two nodes forming ends of a communication link intended to carry a given call are single-version, the SIP telephony service operator concerned may make use of ALG (an abbreviation well known to those skilled in the art standing for Application Layer Gateway) applications, to modify the SDP offers in order to ensure consistency between the address type supported and that contained in the SIP messages received. To do this the SIP servers use information relating to the transport layer and not specific to the SIP protocol to route the calls or to determine use of ALG applications to alter the content of the SDP offers. Such a behavior of the SIP servers is not described in the standard.

Generally, the problem associated with the interconnections of two heterogeneous user agents (that is to say user agents of distinct IP types) has not been studied in detail by the telecommunications community. Except for the ANAT proposal described by (RFC 4091, RFC 4092) which resolves part of the problem, there is in particular no IETF document describing the behavior of the SIP servers to route calls connecting two user agents belonging to different IP environments.

In addition, the existing techniques have the following disadvantages:
use of the ALG applications and of the supplementary functions is not documented. The proxy server PS does not have means specified by the RFC 3261 to enable this task;
the solution is not generic: the philosophy of call routing and of intervention of the proxy server PS depends on the interconnection solution deployed at the transport level;
the proxy server PS does not have means for determining whether a user agent is of the IPv4, IPv6 or dual stack type.

The work carried out by the inventors has led the latter to conclude that, notwithstanding a need that emerges from the foregoing study, there exists in the prior art no arrangement with which to enable a communication means belonging to a communication network conforming to an IP protocol to simply and generically identify the IP address type associated with a given user agent, such an omission explaining why most of the techniques for managing communications between heterogeneous nodes currently being studied are inadequate and do not meet the service needs consisting in allowing heterogeneous communications.

The object of the present invention is to remedy the disadvantages and limitations of the current techniques, taking account of the joint presence of IPv4, IPv6 or IP ISO communication protocols defined by the ISO 8473 standard in IP networks.

More specifically, an object of the invention is to allow the SIP servers to know the IP type of user agents seeking to communicate, in order to allow the successful setting-up of sessions between these agents, whether or not they are of the same type, to facilitate the routing of the calls and to optimize the usage of IP addresses.

According to the invention explained in the present patent application, consideration is given, as a single example, to telephony over IP usually called VOIP for Voice Over IP or usually grouped under the topic of interactive services.

The invention addresses the general issue of transmission services based on the SIP protocol defined by RFC 3261 and deployed both for IPv4 clients and IPv6 clients. These services may be voice, video, presence, etc. services.

The invention proposes a simple mechanism to facilitate the setting-up of SIP sessions between two clients or SIP nodes that are heterogeneous, one attached to an IPv4 domain and the other to an IPv6 domain for example.

Consequently, the subject of the present invention is notably the implementation of an SIP server addressing method for the interworking of heterogeneous SIP nodes making it possible to allocate resources to the SIP servers for recognizing the IP type of the user agents UA. “IP type of a user agent” means the IP protocol version or versions (for example IPv4, IPv6) that this user agent is capable of implementing by means of the network interface(s) that the SIP node that houses it has available. Heterogeneous SIP nodes are therefore SIP nodes that comprise user agents of different IP types.

Another subject of the present invention is also the implementation of an SIP server addressing method for the interworking of heterogeneous SIP nodes making it possible to simplify and therefore facilitate call routing.

Another subject of the present invention is, finally, the implementation of an SIP server addressing method making it possible to optimize the use of IP addresses.

The SIP server addressing method for the interworking of heterogeneous SIP nodes of a first respectively of a second IP type, the subject of the invention, is notable in that it includes at least the allocation to any SIP server, operating in an IP environment of one or the other IP type and furnished with a original address of determined IP type, of an auxiliary address of the same IP type as the original address type and corresponding to a communication address of distinct IP type, the provision, as call address, to any SIP node of the same IP type as this SIP server, of this original address in this IP environment and to any SIP node, of an IP type other than the IP type of this SIP server, of this communication address, the translation of this communication address of one or the other IP type into this auxiliary address of the same IP type as the IP type of this original address.

The operating mode of the addressing method that is the subject of the invention makes it possible to ensure the intercommunication of any SIP node from an IP environment of an IP type corresponding to that of the SIP servers or of a distinct IP type.

The addressing method that is the subject of the invention is also notable in that this communication address is configured as a DNS input of the IP environment of IP type distinct from that of this SIP server.

The invention also covers a method of communication between at least one server operating in an environment of determined IP type and at least one node of the network, this node being of the same IP type or of IP type distinct from the determined IP type.

This communication method is notable in that it comprises the following steps: allocation to the server of at least two addresses in the environment of determined IP type, comprising an address called original address and an address called auxiliary address, with which is associated, by translation, a communication address in an environment of IP type distinct from the determined IP type, provision to this node, as call address of the server, of this original address, if the node is of the same IP type as the determined IP type, respectively of this communication address, if the node is of the IP type distinct from the determined IP type, and, on a call to this server by this node, discrimination of the IP type of this node according to the source or auxiliary address of the server on which this call is received.

The communication method that is the subject of the invention is also notable in that, the server being a registration server, this method also comprises a step of registration of the node according to the discriminated IP type in at least one database.

The method that is the subject of the invention is also notable in that this registration server maintains at least two databases comprising respectively the nodes of the same IP type as the determined IP type and the nodes of IP type distinct from the determined IP type. The addresses stored in these databases are of the same type as that of the proxy server.

The communication method that is the subject of the invention is also notable in that, the node having at least two IP types, namely the determined IP type and at least one IP type distinct from this determined IP type, this method comprises a step of transmission by this node of a registration request to the original address of the registration server, and a step of transmission by this node of at least one registration request to the communication address of the server, intended to be received after translation to the auxiliary address of the server.

The communication method that is the subject of the invention is also notable in that, the server being a proxy server and the call to the proxy server by the node implementing a transmission to the proxy server of a call request from the calling node to a called node, this method also comprises a first step of transmission from the proxy server to the registration server of a request for the IP type of the called node, a second step of transmission from the registration server to the proxy server of the IP type of the called node registered in the database and of an address of the called node and a step of routing of this call from the calling node to the called node, according to the IP type of the calling node discriminated by the proxy server and of the IP type of the called node transmitted by the registration server.

The method that is the subject of the invention is finally notable in that, during the second transmission step, the address of the called node transmitted by the registration server is an address in the environment of determined IP type in which the proxy server operates.

The communication method that is the subject of the invention is also notable in that, during the execution of the registration step, for any SIP node of determined IP type, the IP address registered for said node in the database by the registration server is systematically of the same IP type as the proxy server used by the service, this being so in order to ensure the subsequent use of said address by said proxy server and in particular for the routing of the call.

The invention also covers an SIP registration server operating in an IP environment of determined IP type in the presence of another IP environment of distinct IP type and comprising input-output members connected to a central processor unit and to a working memory, notable in that it comprises, in addition to a source IP address, an auxiliary IP address of IP type corresponding to this IP environment, means for discriminating the IP type of any SIP node effecting a registration according to the source respectively communication call address corresponding to this auxiliary address used by this SIP node, in a registration request transmitted to this SIP registration server, first and second registration database means of each candidate SIP node, corresponding to an SIP node of the same IP type as the IP type of this SIP registration server whose call address is the source address of the latter, respectively of IP type distinct from the IP type of this SIP registration server, whose call address is the auxiliary address of this SIP registration server by means of this communication address.

Finally, the invention covers an SIP proxy server operating by transmission of a request to call a called SIP node by a calling SIP node, of determined type that is identical or distinct, in an IP environment of determined IP type in the presence of another IP environment of distinct IP type, this SIP proxy server comprising input/output members connected to a central processor unit and to a working memory.

It is notable in that it includes, in addition to a source IP address corresponding to this IP environment of determined IP type, an auxiliary address of the same IP type as the IP type of the source address, discrimination means, based on the call request of the IP type from any calling SIP node, according to the call address which may be either the original address or an auxiliary address of this SIP proxy server which corresponds to the initial call address, means for discrimination, by an SIP registration server that is the subject of the aforementioned invention, of the IP type of the called SIP node, and means for the transmission and routing of this call request, taking into account the IP type of the called SIP node.

They will be better understood on reading the description and on observing the following drawings in which, in addition to FIGS. 1a and 1b relating to the prior art:

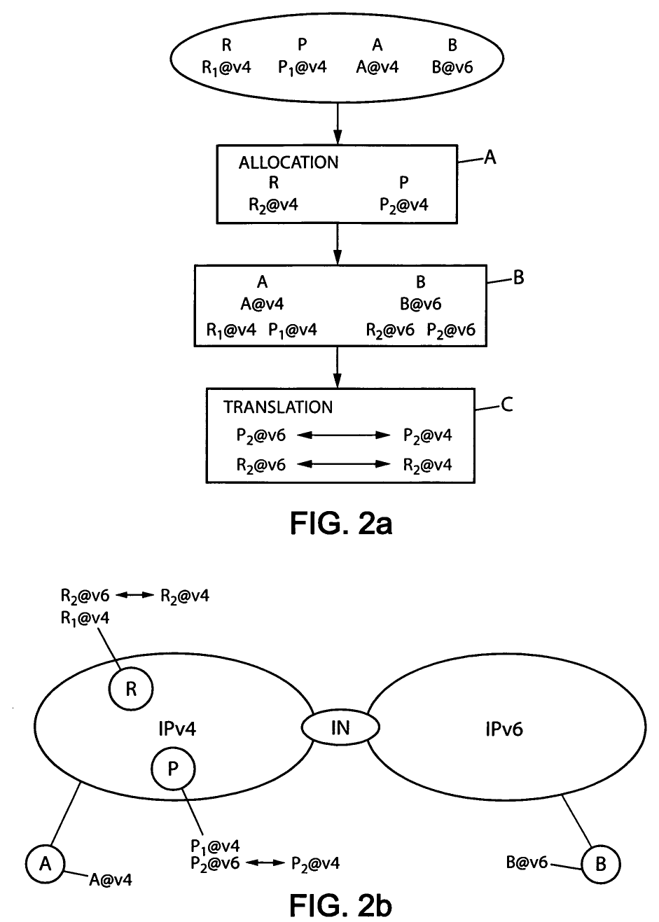

FIG. 2a represents, purely as an illustration, a flow chart of the essential steps of the SIP server addressing method that is the subject of the present invention;

FIG. 2b represents, as an illustration, an IP network configuration in the presence of a first IP environment of IPv4 type and a second IP environment of distinct IP type, IPv6, interconnected via an intermediate node;

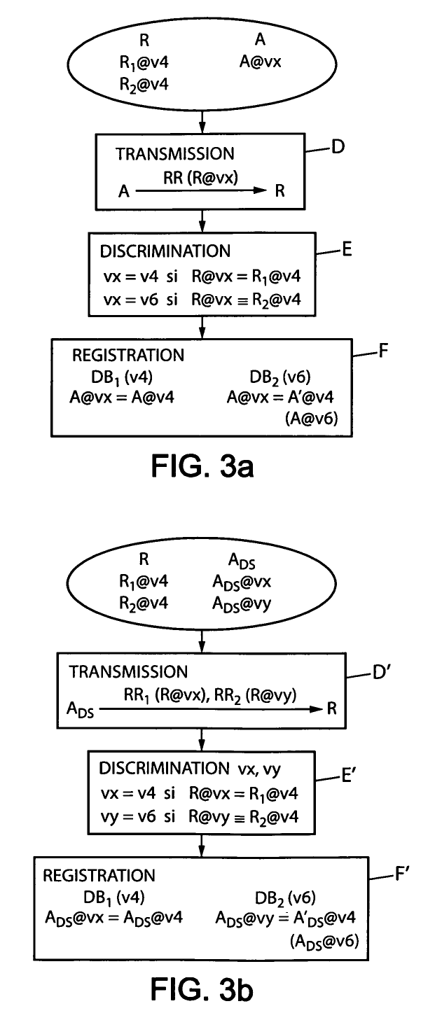

FIG. 3a represents, as an illustration, a flow chart of the essential steps of a process of registration of an SIP node with an SIP registration server, thanks to the implementation of the addressing method according to the subject of the present invention;

FIG. 3b represents, as an illustration, a specific flow chart of the implementation of the registration method illustrated in FIG. 3a, in the case where the SIP node is an SIP node of the dual stack IP type;

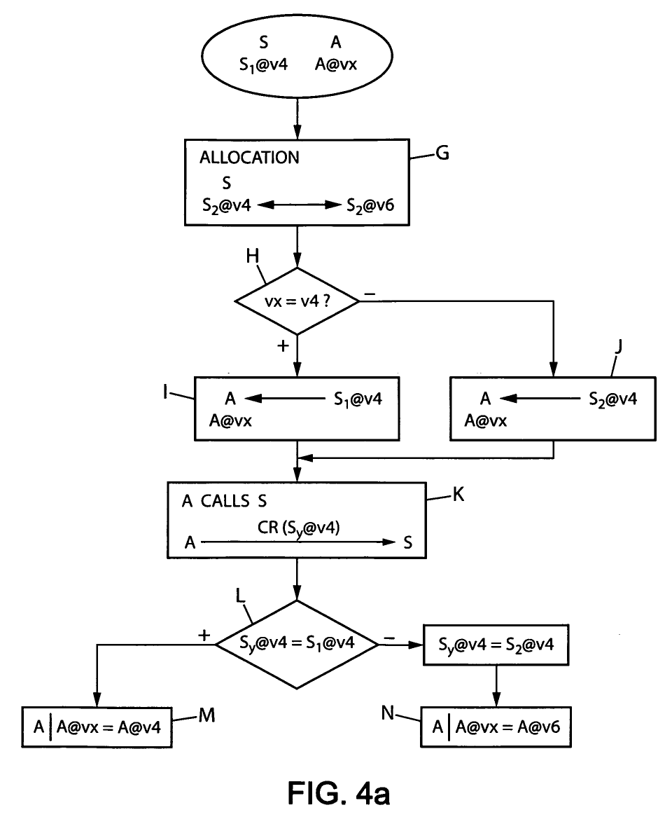

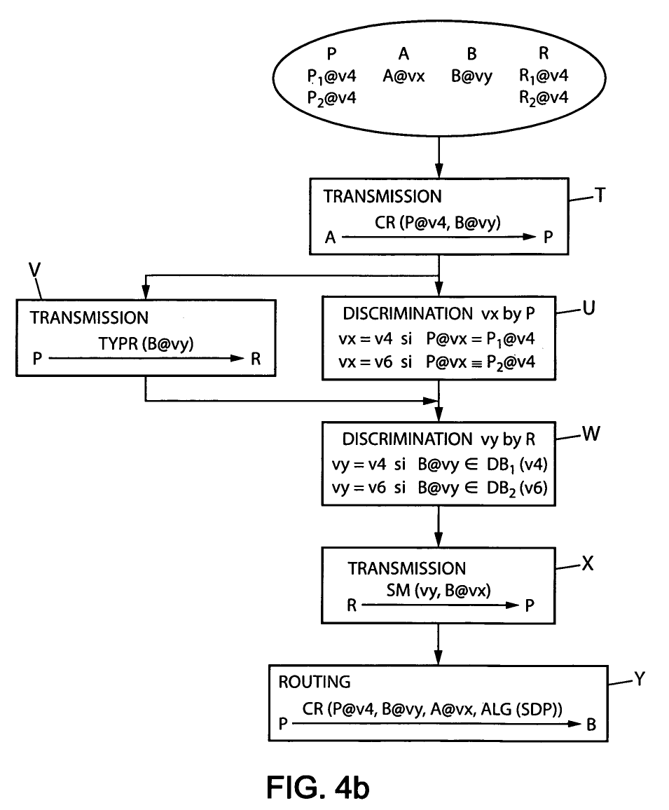

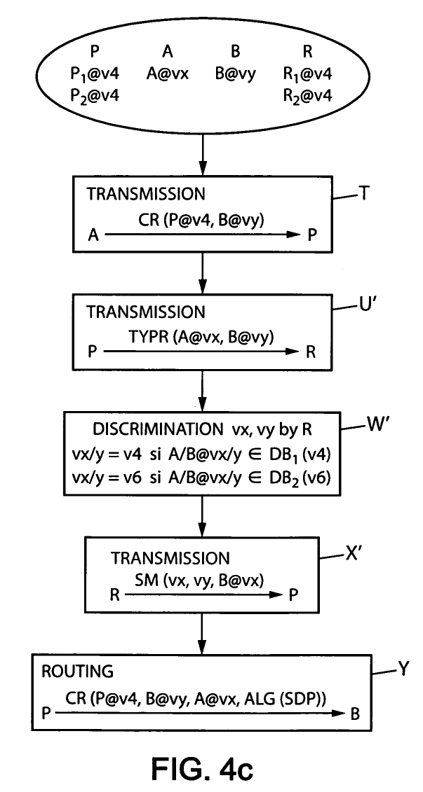

FIG. 4a represents, as an illustration, a flow chart of the essential steps of a method of transmission of a call between a calling SIP node and a called SIP node via an SIP proxy thanks to the addressing method and to the registration process that are subjects of the present invention;

FIG. 4b represents, as an illustration, a flow chart of the essential steps of a method of communication according to the subject of the present invention, between a server operating in an environment of determined IP type and at least one node of a network;

FIG. 4c represents, as an illustration, a variant embodiment of the method of communication illustrated in FIG. 4b, in which the IP type of the calling node and of the called node is established by a registration server on request from a proxy server;

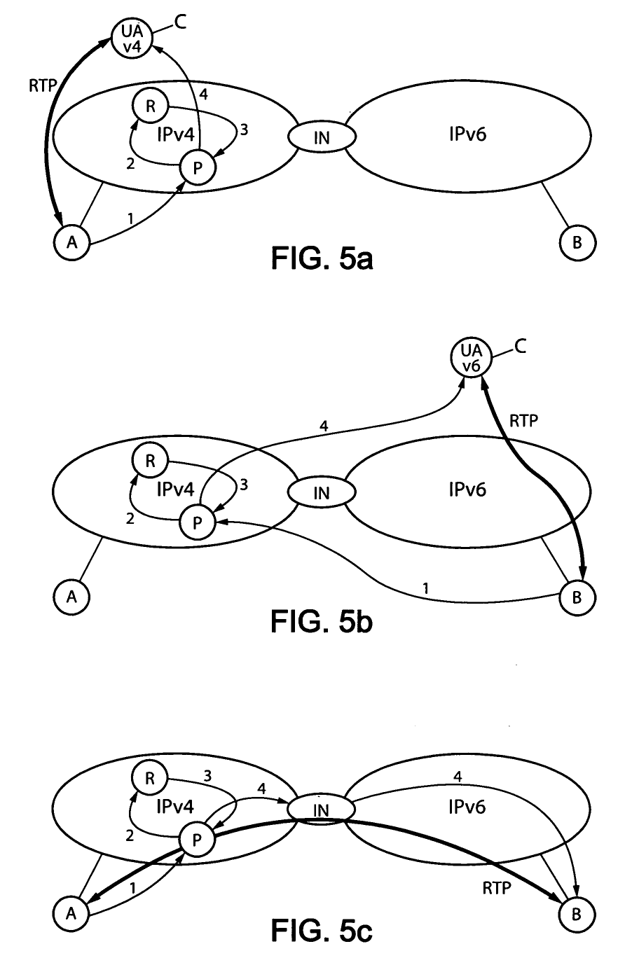

FIGS. 5a to 5c represent, as an illustration, a call transmission protocol between SIP nodes of the same IP type, IPv6 in FIG. 5a, IPv6 in FIG. 5b, and of distinct IP type, IPv4-IPv6 in FIG. 5c;

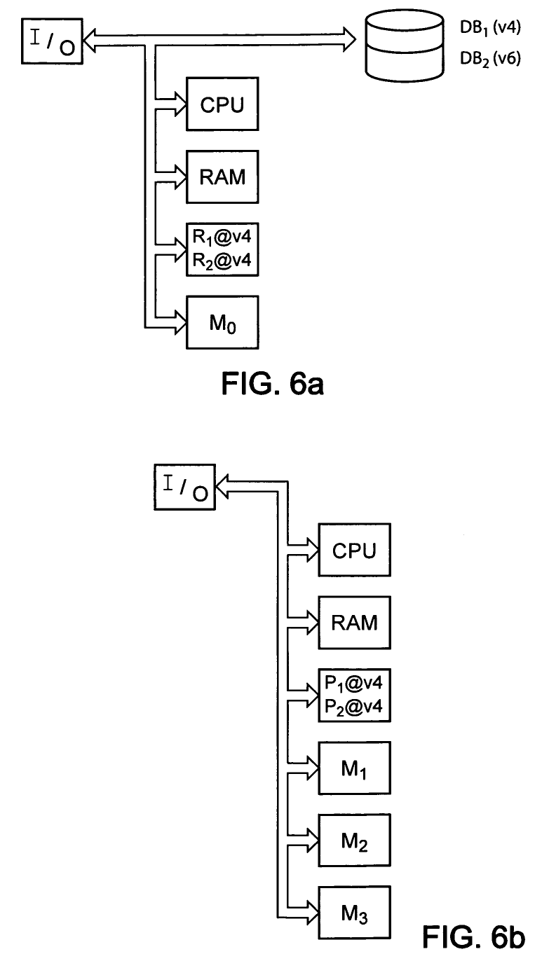

FIG. 6a represents, as an illustration, a functional diagram of an SIP registration server according to the subject of the present invention;

FIG. 6b represents, as an illustration, a functional diagram of an SIP proxy server according to the subject of the present invention.

A more detailed description of the SIP server addressing method for the interworking of SIP nodes of a first respectively of a second IP type will now be given with reference to FIG. 2a and FIG. 2b.

With reference to the aforementioned figures, consideration is given as an example to a first IP environment of IPv4 type and a second IP environment of IPv6 type.

As shown in FIG. 2b, it is indicated that, in a nonlimiting manner, the present description is established in the context in which all of the elements forming the SIP service platform reside in an IPv4 environment and consequently, the aforementioned elements, that is to say the registration server R and the SIP proxy server P, are represented in the IPv4 environment.

It is however specified that the method that is the subject of the present invention is totally applicable by reversing the roles between the IPv4 environment and the IPv6 environment, the registration server element R and the SIP proxy server element P then being placed in the IPv6 environment in this case.

In addition, as a nonlimiting example and in order to make the whole easier to understand, the existence of an intermediate node IN is considered, shown in FIG. 2b situated at the boundary of the IPv4 and. IPv6 environments. This intermediate node represents functionally the elements required for the interconnection of the IPv6 and IPv4 domains such as the NAT-PT elements previously mentioned in the description. However, it is specified that the functions/processes/operations executed by the intermediate node IN may be distributed in the network according to the implementation of the service put in place by an operator of the latter.

With reference to FIGS. 2a and 2b, there is therefore a registration server R with the original address R₁@v4, an SIP proxy server P with the original address P₁@v4, an SIP node A with the address A@v4 in the IPv4 environment and an SIP node B with the address B@v6 in the IPv6 environment.

As shown in FIG. 2a, the method that is the subject of the invention consists in allocating in a step A, to any SIP server, i.e. a registration server R and an SIP proxy server P, operating in an IP environment of one or the other IP type, an auxiliary address of the same IP type as the original address type.

Thus, in the step A of FIG. 2a, the registration server R is allocated the auxiliary address R₂@v4 and the SIP proxy server P is allocated the auxiliary address P₂@v4. The aforementioned auxiliary address is associated with a communication address of IP type distinct from the type of the auxiliary address.

The step A is then followed by a step B consisting in providing any SIP node of the same IP type as the SIP server with the original address of each SIP server in the corresponding environment, and any SIP node of IP type other than the IP type of the SIP proxy server with a communication address corresponding to the auxiliary address allocated to each SIP server.

As is shown in step B of FIG. 2a, after the provision of the aforementioned addresses, in order to place the SIP nodes A and B in communication, the following situation applies:

SIP node A:
A@v4 is the address of the SIP node A in the IPv4 environment;
R₁@v4 is the original address of the registration server R in the IPv4 environment;
P₁@v4 is the original address of the SIP proxy server P in the IPv4 environment;

SIP node B:
B@v6 is the address of the SIP node B in the IPv6 environment;
R₂@v6 is the communication address of the registration server R;
P₂@v6 is the communication address of the SIP proxy server P.

The step of providing the aforementioned addresses is then followed by a step C consisting in translating the communication address of one or the other IP type into the auxiliary address of the same IP type as the IP type of the original address of the SIP servers.

In step C of FIG. 2a, the translation operation is expressed by to the following relations:

P₂@v6 [symbol] P₂v4

R₂@v6 [symbol] R₂v4.

It is therefore understood that, thanks to the process of allocating auxiliary addresses, and in fact the dual addressing of each SIP server involved, the intercommunication between any SIP node of one and/or the other IP environment, IPv4 or IPv6, may thus be executed.

Generally, the original addresses R₁@v4 and P₁@v4 of the SIP servers are configured in the DNS inputs designated domain name naming inputs in a corresponding IP environment, IPv4.

The same applies in relation to the communication addresses R₂@v6 and P₂@v6 which may be configured as DNS input for the IPv6 environment.

Finally, it is specified that the SIP servers that are the subject of the dual addressing, according to the addressing method that is the subject of the invention, include any registration server respectively any SIP proxy server of one or the other of the IP environments.

A method of registering an SIP node of a determined IP type with a registration server, such as the server R represented in FIG. 2b, will now be described with reference to FIGS. 3a and 3b.

With reference to the aforementioned FIG. 3a, the aforementioned SIP node may consist of an SIP node of IPv4 or IPv6 type, the registration server R operating in an IP environment of a same IP type as, or of an IP type other than, that of the SIP node in question.

As shown in FIG. 3a, the registration server R naturally comprises a original address R₁@v4 in the nonlimiting example of FIG. 2b, and an auxiliary address of IP type corresponding to this IP environment, that is to say the address R₂@v4 allocated according to the addressing method as described above in the description with FIG. 2a and FIG. 2b.

With reference to FIG. 3a, a node or terminal A of one of the IPv4 or IPv6 types is considered, this terminal A thus being allocated an address A@vx, x designating either the IPv4 type or the IPv6 type or else the dual stack type as described above in the description.

With reference to FIG. 3a, the method that is the subject of the invention consists at least, on transmission of a registration request denoted RR(R@vx), in discriminating the IP type of the SIP node A, according to the source respectively auxiliary call address corresponding to the communication address used initially by the SIP node A to transmit the registration request.

It is understood in particular that, in the registration address, R@vx indicates either the original address R₁@v4 of the registration server or, on the contrary, a communication address such as the address R₂@v6 mentioned above in the description with reference to FIG. 2a.

The aforementioned communication address naturally corresponds to the auxiliary address R₂@v4 allocated to the registration server R as mentioned above in the description.

In the step D of FIG. 3a, the transmission operation is marked by the symbolic relation:

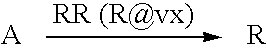

The step D is then followed by a step E consisting in discriminating the IP type of the SIP node A according to the original respectively communication call address corresponding to the auxiliary address used by the SIP node in the aforementioned registration request.

In the step E of FIG. 3a, the discrimination operation is given by the relations:

vx=v4 if R@vx=R₁@v4,

vx=v6 if R@vx≡R₂@v4.

In the above relations and in the rest of the description, the = sign represents the direct equality of the addresses and the ≡ sign represents the equality of the addresses after translation by the intermediate node IN.

Specifically, it is understood that, when the call address is a communication address, the latter is translated into an auxiliary address which naturally makes it possible to discriminate the IP type of the SIP node on registration.

In the above relations, vx designates in fact the discriminated IP type of the SIP terminal.

The step E is then followed by a step F consisting in establishing and maintaining a first database DB₁(v4) and a second database DB₂(v6) of the registration of each SIP node.

Specifically, it is understood that, following the discrimination carried out in the step E, each SIP node corresponds to an SIP node of the same IP type as the IP type of the proxy server, of v4 type in the example given, with reference to FIG. 2b and for which the call address is the original address of the latter.

Conversely, an SIP node is of IP type distinct from the IP type of the proxy server, when the call address corresponds to the auxiliary address of this registration server via the communication address.

The establishment of the aforementioned registration databases may correspond to the insertion of a reference to the address of each corresponding SIP node, denoted for this reason A@vx=A@v4 when the candidate terminal A is registered in the first registration database DB₁(v4), and A@vx=A′@v4, the address A@v6 having been translated en route into this address A′@v4 when the address of the corresponding SIP node corresponds to an SIP node of v6 type, the corresponding address A′@v4 being registered in the second registration database DB₂(v6).

It is understood in particular that the registration process that is the subject of the invention is implemented because all the SIP nodes of IPv4 type, by configuration, contact the registration server R on its original address exclusively, while all the SIP nodes of IPv6 type make contact with the registration server R only via the communication address R₂@v6, which is naturally translated into the auxiliary address R₂@v4. The registration server therefore receives any request transmitted by an SIP terminal of IPv6 type exclusively on its auxiliary address.

In the case of a dual stack SIP terminal A_{DS}, it is preferably the address used by the latter to register with the registration server R that makes it possible to determine the base in which it appears.

In addition, and in a preferred nonlimiting embodiment, it is indicated that, for an optimized registration procedure and in the case of an SIP node of dual stack IP type, the process may also consist, as shown in FIG. 3b, in transmitting in a step D′ a registration request of IP type corresponding to the IP type of the proxy server and in transmitting a registration request of IP type distinct from the IP type of the proxy server.

This operation in the step D′ of FIG. 3b is expressed by the relation:

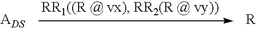

In the above relation, it is understood that RR₁(R@vx) designates the registration request of IP type corresponding to the IP type of the proxy server for example and that RR₂(R@vy) designates a registration request of IP type distinct from the IP type of the proxy server for example.

The IP types of the two requests may naturally be reversed.

The step D′ is then followed by a step E′ consisting in discriminating the IP type of the SIP node based on each of the two aforementioned transmitted registration requests.

In the step E′ shown in FIG. 3b, the discrimination of the types vx and vy is represented by the symbolic relation:

vx=v4 if R@vx=R₁@v4,

vy−v6 if R@vy≡R₂@v4.

As in the case of FIG. 3a, the ≡ sign represents the equality of the addresses after translation by the intermediate node IN.

In the above relations, the equality of the call address of the registration server and of the auxiliary address of the registration server is understood to be the equality after conversion of the communication address forming the call address.

Step E′ is then followed by a step F′ consisting in establishing and maintaining jointly the first and the second registration databases DB₁(v4) and DB₂(v6) for the SIP node of dual stack type, based on the two discriminated IP types.

It is therefore understood that, by implementing the registration process according to the invention shown in FIG. 3b and for a dual stack SIP node, the latter is then present in both of the registration databases.

In addition, it is indicated that any SIP node of IPv6 type is represented in the IPv4 environment by an IPv4 address for which a correlation is made with the IPv6 address of the SIP node of IPv6 type in its original IP environment. The registration request for an SIP node of IPv6 type therefore arrives at the auxiliary address R₂@v4 of the registration server R and the IPv4 address representing the SIP node of IPv6 type in the IPv4 environment is then available for the registration operation since it is supplied by the adaptation functions implemented elsewhere by the operator of the IPv4 network.

Accordingly, the registration databases maintained by the registration server R may then contain only IPv4 addresses which naturally ensures total consistency of the network transmission service.

A method of communication between at least one server S operating in an environment of determined IP type, taken as a nonlimiting example as the IPv4 type, and at least one node A of the network, this node A being able to be of the same IP type, IPv4, or of IP type, IPv6, that is distinct from the determined IP type, IPv4, of the server S, will now be described with reference to FIG. 4a.

With reference to the aforementioned FIG. 4a, the user allocates, in the step G, at least two addresses to the server S, in the environment of determined IP type, IPv4. These addresses comprise an original address, denoted S₁@v4, and a auxiliary address, denoted S₂@v4. This auxiliary address is associated by translation with a communication address in an environment of IP type, IPv6, distinct from the determined IP type, IPv4. The communication address in the step G is denoted S₂@v6.

The node A is then provided with, as the call address of the server S, either the original address, S₁@v4, if the node A is of the same determined IP type, IPv4, or the communication address, S₂@v6, if the node A is of IP type, IPv6, that is distinct from the determined IP type, IPv4.

The corresponding operation is shown in FIG. 4a for a node A with the address A@vx a priori of one or the other IP type, IPv4 or IPv6, by a test H to verify the IP type of the address of the node A, by the comparison:

Vx=V4?

On a positive response to the test H, the original address S₁@v4 is supplied in the step I as the call address of the server S to the node A, according to the relation:

A→S₁@v4

A@vx

Otherwise, on a negative response to the test H, the communication address, S₂@v6, distinct from the determined IP type, IPv4 is supplied in step J.

On a call, in the step K, to the server S by the node A, by transmission of a call request represented by the relation

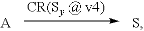

where CR(Sy@v4) designates the call request, Sy@v4 designates either the original address S₁@v4, or the communication address S₂@v6 which is translated en route by IN into the auxiliary address S₂@v4 of the server S, the user, in the step L, discriminates the IP type of the node A, according to the original address S₁@v4 or auxiliary address S₂@v4 of the server at which this call has been received.

In FIG. 4a, the test step L is represented by the relation:

S_{y}@v4=S₁@v4.

On a positive response to the test L, the node A is discriminated, in the step M, as belonging to the determined IP type IPv4, A|A@vx=A@vx=A@v4. Otherwise, on a negative response to the test L, the node A is discriminated in the step N as belonging to the IP type, IPv6, distinct from the determined IP type A|A@vx=A′@v4 which is the translation of A@v6 by IN, because S_{y}@v4=S₂@v4 when the call is received by P.

When the server S is a registration server, the communication method also comprises a registration step, as described with reference to FIGS. 3a and 3b.

A more detailed description of a method of transmission of a call from an SIP node called by a calling SIP node is now given with reference to FIG. 4b.

With reference to the aforementioned FIG. 4b, it is indicated that the calling SIP node, such as the node A, is of a determined IP type, the address of this node being designated A@vx and the called SIP node B is an SIP node also of the determined IP type, identical to or distinct from the type of the calling SIP node. The address of the called SIP node is denoted B@vy.

The call is transmitted via an SIP proxy server denoted P operating in an IP environment of the same IP type or of an IP type distinct from the IP type of the calling SIP node.

As an example, consider the SIP proxy server P which then comprises a original address P₁@v4 and an auxiliary address P₂@v4 of IP type corresponding to this IP environment and allocated according to the addressing method that is the subject of the invention, as described above in the description with reference to FIGS. 2a and 2b.

In addition, it is considered that the calling SIP node A and the called SIP node B have satisfied the process of registration with the server R which itself has its original address R₁@v4 and its auxiliary address R₂@v4 as described above in the description with reference to FIGS. 3a and 3b.

The call transmission method that is the subject of the invention comprises at least, as shown in FIG. 4b, following the transmission in the step T of a call request from the SIP calling node to the SIP proxy server, this call request being denoted:

CR(P@v4, B@vy),

the discrimination, at the SIP proxy server, of the type of the calling SIP node from the original call address respectively the communication address corresponding to the auxiliary address allocated to the SIP proxy server.

It is understood, in particular, that in the step U the discrimination may be directly carried out by the SIP proxy server P on the basis of the call in the call request, either of the original address of the SIP proxy server, in which case the calling SIP node A corresponds to a node of IP type identical to that of the SIP proxy server P, or, on the other hand, to a node of IP type distinct from that of the SIP proxy server P, when the call address of the latter corresponds, after conversion, to the auxiliary address P₂@v4.

The step U may then be followed by a step W consisting in discriminating, at the registration server R, the IP type of the called SIP node based on the registration bases DB₁(v4) and DB₂(v6). This operation is carried out by a call V to the registration server R by the SIP proxy server P as will be described later in the description.

In the step W of FIG. 4b, the operation of discrimination of the type of called terminal is given by the symbolic relation:

vy=v4 if B@vyεD₁(v4),

vy=v6 if B@vyεDB₂(v6).

The aforementioned step W is then followed by a step X for transmission from the registration server to the SIP proxy server of the discriminated IP type for the called terminal B and of the communication address of the called SIP node for qualification and routing of the call request in the step Y represented in FIG. 4b.

In the transmission step X, the transmission operation is represented by a service message according to the relation:

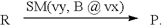

Finally, the routing operation in the step Y is represented by the relation:

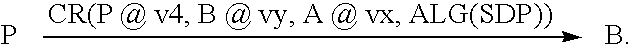

The operating mode of the call transmission according to the method that is the subject of the invention as shown in FIG. 4b may then be explained in the following manner.

During the setting-up of a call, the method that is the subject of the invention allows any SIP proxy server to determine, simply in the context of the call, notably the IP type of the calling respectively called SIP node in order to optimize the routing choices and notably the use of the aforementioned adaptation functions.

In the step U, the SIP proxy server determines the IP type of the calling SIP node A. For this purpose, it relies on the knowledge of the addresses used by the SIP nodes in order to contact it.

Specifically, by configuration, all the SIP nodes of IPv4 type contact the SIP proxy server P exclusively on its original address. Furthermore, the SIP nodes of distinct IP type, namely of IPv6 type in the example given, contact the aforementioned proxy server on its communication address P₂@v6. The latter address corresponds, as described above, to the auxiliary address P₂@v4 of the proxy server P in question since a correlation is ensured between these two addresses by the service applied furthermore by the operator of the IP network.

The SIP proxy server P in question therefore receives any request sent by an SIP node of type distinct from the IP type of this SIP server exclusively on its auxiliary address. The SIP proxy server P may therefore deduce that an SIP node is of the dual stack type when this SIP node has been referenced in each of the registration databases described above.

In addition, any dual stack SIP node uses the attribute “ANAT” to enter these two addresses.

In the step W, the registration server R determines the IP type of the called SIP node P.

In a conventional processing of an SIP call, the intermediate proxy server contacts the registration server for the latter to supply the address with which the called SIP node B was previously registered. The registration server R returns to the SIP proxy server P the address required after having consulted its registration database.

On the other hand, the method that is the subject of the invention introduces an additional element into these interchanges. Specifically, the SIP proxy server P also requires the IP type of the SIP node called in the step V. To respond, the registration server R relies on its registration databases, since the IP type of the reference of the registered SIP node is the registration criterion in the registration database in which the latter has been registered.

When this information has been determined, the registration server R transmits the latter in the step X, typically at the same time as the provision of the address of the called SIP node B.

When this operation has been executed, that is to say after the step W of FIG. 4b, the SIP proxy server P therefore has the information necessary to qualify the call, which, in the step Y, allows the latter to route the call in an optimal manner.

In particular, for a calling SIP node and a called SIP node of distinct IP type, the SIP proxy server routes the call by means of ALG adaptation functions making it possible to modify the content of the SDP field of the call request and to incorporate therein information intended for the called SIP node.

Thus, with reference to FIGS. 4a and 4b, when the server S is a proxy server P and when the call to the proxy server P by the node A implements a transmission T to the proxy server of a call request CR(P@v4, B@vy) from the calling node A to the called node B, the communication method that is the subject of the invention may also include at least the step V of transmission, from the proxy server P to the registration server R, of a request for the IP type of the called node B according to the relation:

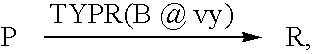

following the step U of discrimination of the IP type of the called node by the registration server R, then the step X of transmission, from the registration server R to the proxy server P, of the IP type, vy, of the called node B, registered in the database and of an address B@vy of the called node. The step X is followed by the step Y of routing of the call from the calling node A to the called node B, according to the IP type, vx, of the calling node discriminated by the proxy server P in the step U and of the IP type, vy, of the called node B transmitted by the registration server R in step X.

As a variant, as shown in FIG. 4c, the steps U and V of FIG. 4b are replaced by a step U′ of transmission by the proxy P of a type request for the type of the calling node A and of the called node B, expressed:

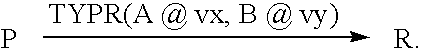

The steps U and V of FIG. 4b are deleted. The step U′ is followed by a step W′ of discrimination of the IP types, vx, vy of the calling terminal A@vx and of the called terminal B@vy by the registration server R according to the relation:

vx/y=v4 if A/B@vx/yεDB₁(v4)

vx/y=v6 if A/B@vx/yεDB₂(v6).

The step W′ is followed by a step X′ of transmission from the registration server R to the proxy server P of a service message comprising the respective IP types vs, vy of the calling terminal A and of the called terminal B, accompanied by the communication address of the called terminal B@vx according to the relation:

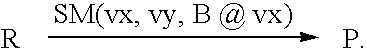

The step X′ is followed by the routing step Y described with reference to FIG. 4b. In the variant embodiment of FIG. 4c, the type of the calling node A and of the called node B is determined by the registration server R on request from the proxy P.

A representation of the various call transmission cases is now described with reference to FIGS. 5a to 5c.

FIG. 5: The case in which the calling and called SIP nodes are of the same IP type, or one of the two is of dual stack type.

In this situation, the SIP proxy server P does not make use of the ALG adaptation functions, since the information contained in the SDP field of the call request will be relevant for both of the SIP nodes in question, the calling and called nodes.

FIG. 5a illustrates the case of the call between two SIP nodes of the same type IPv4 between the SIP node A and the user agent UA of the same type of an SIP node C.

The successive SIP messages are as follows:
1) transmission of the call request from the SIP node A to the SIP proxy server P;
2) transmission of a service message between the SIP proxy server P and the registration server R for interrogation of the types according to the steps U and V;
3) transmission of a service message between the registration server R and the SIP proxy server P according to the step W;
4) transmission of an “INVITE” message by the SIP proxy server to the user agent UA of the SIP node C, then the interchange of the RTP streams.

FIG. 5b: Transmission of a call between SIP nodes of the same type, IPv6.

In this situation, the implementation of the ALG adaptation functions is also not required. Specifically, the IPv6 information contained in the SDP field of the SIP messages are relevant for both SIP nodes which are of the same SIP type, IPv6.

Not routing the call to adaptation functions typically implementing an ALG application also makes it possible to maintain the setting-up of the RTP streams within the IPv6 environment without going through an intermediate node. However, the service elements and in particular those represented on the intermediate node IN are in principle situated in an IPv4 IP environment. Consequently, the call signaling passes through a simple relay function from the point of view of transport between the IPv4 environment and the IPv6 environment.

The interchange of the successive SIP messages 1 to 4 is represented in the drawing of FIG. 5b.

FIG. 5c: The case of a call between heterogeneous clients of a distinct IP type.

If the calling and called SIP nodes A and B represented in FIG. 5c are of a distinct IP type, the IP proxy routes the call to the adaptation functions, which typically implement an SIP ALG application. Such applications also make it possible to modify the content of the SDP field of the messages in order to incorporate therein information elements that are relevant for the SIP node that is the recipient of the message.

The interchange of the successive SIP messages 1 to 4 is also represented in FIG. 5c in this situation.

The method and the protocol used for the interchanges between the SIP proxy server and the registration server according to the subject of the invention depend on the implementation. In particular, many implementations have the particular feature of having the registration server R and the SIP proxy reside within the same physical entity, which makes it possible to lighten the overall implementation of the additional function of determining the IP types of the calling terminal and the called terminal, according to the subject of the present invention.

A more detailed description of an SIP registration server operating in an IP environment of determined type, in the presence of another IP environment of distinct IP type, according to the subject of the invention, will now be given with reference to FIG. 6a.

In a conventional manner, such a server comprises input/output members, denoted I/O, connected to a central processor unit CPU and a working memory RAM.

It is noteworthy in that it also comprises a original IP address denoted R₁@v4 in FIG. 6a and an auxiliary address of IP type corresponding to this IP environment and denoted R₂@v4. These two addresses may advantageously be stored in a programmable memory for example.

In addition, as shown in FIG. 6a, the registration server that is the subject of the invention comprises a module MO for discriminating the IP type of any SIP node that is a candidate for a registration, according to the original call address respectively the communication address corresponding to the aforementioned auxiliary address, used by the SIP node in a registration request made to this registration server.

Finally, as also shown in FIG. 6a, the registration SIP server that is the subject of the invention comprises resources of first and second registration databases DB₁(v4) and DB₂(v6), of each SIP node that is a candidate for the registration corresponding to an SIP node of a same IP type as the IP type of the proxy server whose call address is the original address of the latter, R₁@v4, respectively of a type distinct from the IP type of the registration SIP server, whose call address is the auxiliary address of this registration SIP server, address R₂@v4, by means of the communication address.

In addition, and according to a notable feature of the registration SIP server that is the subject of the invention, it is indicated that for any SIP node of dual stack IP type, the first registration database DB₁(v4) comprises a reference to the IP address of the SIP node of IP type corresponding to the IP type of the proxy server of IP type and the second registration database DB₂(v6) comprises a reference to the IP address of the SIP node of IP type distinct from the IP type of the proxy server of IP type.

FIG. 6b represents an SIP proxy server according to the subject of the present invention and operating in transmission of a request to call a called SIP node by a calling SIP node.

It comprises input/output members I/O connected to a central processor unit CPU and a working memory RAM.

It is also noteworthy in that it includes a original IP address P₁@v4 corresponding to the IP environment of determined IP type, in which the proxy server is installed, and an auxiliary address of the same IP type as the IP type of the original address, address denoted P₂@v4. These addresses may be stored in a programmable memory.

Finally, it comprises a module M₁ for discrimination, based on the call request, of the IP type of any calling SIP node based on the original call address respectively communication address corresponding to the auxiliary address of the SIP proxy server, as described above in the description.

It also comprises a module M₂ for discrimination by interrogation of a registration SIP server of the IP type of the called SIP node as described above in the description.

It finally comprises a module M₃ for the transmission and routing of the call request taking account of the IP type and of the communication address of the called SIP node.

In particular, when the calling SIP node and the called SIP node are of distinct type, the aforementioned module M₃ executes the routing of the call request via adaptation functions making it possible to modify the content of the SDP field of the call request and to incorporate therein information intended for the called SIP node.

The invention also covers a computer program comprising a series of instructions stored on a storage medium and able to be executed by a computer or a dedicated device, such as a registration SIP server. The registration SIP server effects the registration of an SIP node of determined IP type in an IP environment of the same type or of another IP type.

This registration SIP server comprises a original address and an auxiliary address of IP type and an auxiliary address of IP type corresponding to the IP environment, this auxiliary address being allocated as described above in the description with reference to FIGS. 2a and 2b. It is noteworthy in that, when executed, this program executes the process of registration of an SIP node as described above in the description with reference to FIGS. 3a and 3b. This computer program may consist of a software module, such as the module M₀ described above with reference to FIG. 6a.

Finally the invention covers a computer program comprising a series of instructions stored on a storage medium and able to be executed by a computer or a dedicated device, such as an SIP proxy server, working by transmission of a call request for a called SIP node by a calling SIP node of determined IP type that is identical or distinct.

The SIP proxy server comprises a original address and an auxiliary address of IP type corresponding to the IP environment and allocated according to the addressing method as described above in the description with reference to FIGS. 2a and 2b. The calling and called SIP nodes have satisfied the process of registration of SIP nodes, as described above in the description with reference to FIGS. 3a and 3b.

It is noteworthy in that, when it is executed, this program executes the call transmission method as described above in the description with reference to FIG. 4b. This program may be implemented in the form of distinct software modules such as the modules M₁ to M₃ described with reference to FIG. 6b.

1. A method for addressing servers for the interworking of nodes of a first respectively of a second IP type, wherein it comprises at least the following steps:
the allocation to any server, operating in an IP environment of one or the other IP type and furnished with a original address of determined IP type, of an auxiliary address of the same IP type as the original IP address type, said auxiliary address corresponding to a communication address of IP type distinct from this determined IP type;
the provision, as call address, to any node of the same IP type as said server, of said original address and to any heterogeneous node, of IP type other than the IP type of said server, of said communication address;
the translation of said communication address of one or the other IP type into said auxiliary address, of the same IP type as the IP type of the original address.

2. The method as claimed in claim 1, wherein said communication address is configured as a DNS input of the IP environment of IP type distinct from that of said server.

3. The method as claimed in claim 1, wherein said servers include any registration server respectively any proxy server of one or the other of the IP environments.

4. A method between at least one server operating in an environment of determined IP type and at least one node of a network, said node being of the same IP type or of IP type distinct from said determined IP type, wherein it comprises the following steps:
allocation to said server of at least two addresses in said environment of determined IP type, comprising an address called source address and an address called auxiliary address, with which is associated, by translation, a communication address in an environment of IP type distinct from the determined IP type;
provision to said node, as call address of said server:
of said source address if said node is of the same IP type as said determined IP type;
of said communication address if said node is of an IP type distinct from said determined IP type;
on a call to said server by said node, discrimination of the IP type of said node according to the source or auxiliary address of said server on which said call is received.

5. The communication method as claimed in claim 4, wherein said server is a registration server, the method also comprises a step of registration of said node according to said discriminated IP type in at least one database.

6. The communication method according to claim 4, wherein said server is a registration server which maintains at least two databases comprising respectively said nodes of the same IP type as said determined IP type and said nodes of IP type distinct from said determined IP type.

7. The communication method as claimed in claim 6, wherein said node has at least two IP types, namely said determined IP type and at least one IP type distinct from said determined IP type, said method comprising:
a step of transmission by said node of a registration request to said source address of said registration server;
a step of transmission by said node of at least one registration request to said communication address of said server, intended to be received after translation to said auxiliary address of said server.

8. The communication method as claimed in claim 6, characterized in that, wherein said server being is a proxy server, said call to said proxy server by said node implementing a transmission to said proxy server of a call request from said calling node to a called node, the method also comprising:
a first step of transmission from said proxy server to said registration server of a request for the IP type of said called node;
a second step of transmission from said registration server to said proxy server of the IP type of said called node registered in said database and of an address of said called node;
a step of routing of said call from said calling node to said called node, according to the IP type of said called node transmitted by said registration server.

9. The communication method as claimed in claim 8, wherein, during said second transmission step, the address of said called node transmitted by said registration server is an address in said environment of determined IP type in which said proxy server operates.

10. A registration server operating in an environment of determined IP type, in a network comprising another environment of IP type distinct from the determined IP type, said server comprising input-output members connected to a central processor unit and to a working memory, said server also comprising at least two addresses in said environment of determined IP type, comprising an address called source address and an address called auxiliary address, with which is associated, by translation, a communication address in said environment of distinct IP type, and:
means of discriminating the IP type of a node that is a candidate for a registration, according to the source or auxiliary call address of said server on which is received a registration request transmitted to this registration server by said candidate node;
means of registering said node according to said discriminated IP type in at least one database.

11. The registration server as claimed in claim 10, wherein it comprises means for registering said node in at least one first and one second databases comprising respectively said nodes of the same IP type as said determined IP type and said nodes of IP type distinct from said determined IP type.

12. The registration server as claimed in claim 11, wherein, for a node of the dual stack IP type, said first registration database comprises:
a reference to the IP address of said node of IP type corresponding to the determined IP type of said registration server; and, in that said second registration database comprises:
a reference to the IP address of said node of IP type distinct from the determined IP type of said registration server.

13. A proxy server operating in an environment of determined IP type, in a network comprising another environment of an IP type distinct from the determined IP type, said server operating by transmission of a request to call a called node by a calling node, of IP types that are identical or distinct from said determined IP type, and comprising input-output members connected to a central processor unit and to a working memory, said server comprising at least two addresses in said environment of determined IP type, comprising an address called source address and an address called auxiliary address, with which is associated, by translation, a communication address in said environment of distinct IP type and;
means of discriminating the IP type of said calling node, according to the source or auxiliary call address of said server on which said call request is received;
means of discriminating, by interrogation of a registration server according claim 7, the IP type of said called node;
means of transmitting and routing said call request, taking into account the IP type and the communication address of said called node.

14. The proxy server as claimed in claim 13, wherein, for a calling node and a called node of distinct IP type, said proxy server executes the routing of said call request via adaptation functions making it possible to modify the content of the SDP field of said call request and to incorporate therein information intended for said called node.

15. A computer program comprising a series of instructions stored on a storage medium and able to be executed by a computer or a dedicated device, such as a registration server, said registration server effecting the registration of a node of determined IP b type in an IP environment of the same type or of another IP type, said registration server comprising a source address and an auxiliary address of IP type corresponding to said IP environment allocated according to the method as claimed in claim 1, wherein, when executed, said program executes a step of registration of a node according to the IP type of the latter discriminated in at least one database.

16. The computer program comprising a series of instructions stored on a storage medium and able to be executed by a computer or a dedicated device such as a proxy server working by transmission of a request to call a called node by a calling node, of identical or distinct determined IP type, in an IP environment of a determined IP type in the presence of another IP environment of distinct IP type, said proxy server comprising a source address and an auxiliary address of IP type corresponding to said IP environment allocated according to the addressing method as claimed in claim 1, said calling node and said called node having satisfied a registration process, wherein, when executed, said program executes the communication method between at least one server operating in an environment of determined IP type and at least one node of a network as claimed in claim 4.

17. The communication method as claimed in claim 5, wherein said node has at least two IP types, namely said determined IP type and at least one IP type distinct from said determined IP type, said method comprising:
a step of transmission by said node of a registration request to said source address of said registration server;
a step of transmission by said node of at least one registration request to said communication address of said server, intended to be received after translation to said auxiliary address of said server.

18. The communication method as claimed in claim 5, wherein said server is a proxy server, said call to said proxy server by said node implementing a transmission to said proxy server of a call request from said calling node to a called node, the method also comprising:
a first step of transmission from said proxy server to said registration server of a request for the IP type of said called node;
a second step of transmission from said registration server to said proxy server of the IP type of said called node registered in said database and of an address of said called node;
a step of routing of said call from said calling node to said called node, according to the IP type of said called node transmitted by said registration server.

19. The communication method as claimed in claim 18, wherein, during said second transmission step, the address of said called node transmitted by said registration server is an address in said environment of determined IP type in which said proxy server operates.
